(19) United States
(12) Patent Application Publication
(10) Pub. No.: US 2007/0287380 A1
(43) Pub. Date: Dec. 13, 2007

(54) Wireless Hybrid Headset

(75) Inventors: Siew Kok Hui, Singapore (SG); Eng Sui Tan, Singapore (SG); Kok Heng Loh, Singapore (SG)

Correspondence Address: LAWRENCE Y.D. HO & ASSOCIATES PTE LTD, 30 BIDEFORD ROAD, #02-02, THONGSIA BUILDING, SINGAPORE, 229922, SG

(73) Assignee: BITwave Pte Ltd, Singapore (SG)

(21) Appl. No.: 11/754,371

(22) Filed: May 29, 2007

Related U.S. Application Data
(60) Provisional application No. 60/803,369, filed on May 29, 2006.

(51) Int. Cl. H04B 5/00

(52) U.S. Cl. 455/41.1

(57) ABSTRACT

The present invention provides a wireless electronic device for audio signal procession and transmission. In one embodiment, the wireless electronic device comprises a primary unit being worn on one ear of a user, wherein the primary unit comprises a main electrical circuitry for receiving, processing, and transmitting audio signals, wherein the audio signals may be received from different sources; a speaker being electronically coupled to the main electrical circuitry for outputting the processed audio signals to a user; a microphone being electronically coupled to the main electrical circuitry for audio signal inputting to the main electrical circuitry; an interface being electronically coupled to the main electrical circuitry for allowing connection with a secondary attachment; and a power source for powering the wireless electronic device; whereby when the interface is not connected with the secondary attachment, the wireless electronic device functions as a mono headset.

### FIELD OF THE INVENTION

The present invention generally relates to audio devices, and more particularly to a wireless hybrid headset that is versatile in functioning as a standalone mono headset, a stereo headset, or a speaker-phone system.

### BACKGROUND OF THE INVENTION

Wireless headsets are popular items in the market of consumers' electronic devices, having different designs and configurations. For example, due to the advent of the Bluetooth technology, mono headsets have been combined with mobile phones for hands-free communications. Mono headsets are designed to be worn on one ear of a user so that they are typically small, lightweight and handy to use. Mono headsets are usually equipped with a basic microphone for voice input and a speaker for speech output for communication purposes solely. Therefore, current mono headsets are usually neither compatible nor suitable for music streaming due to poor audio fidelity and the lack of stereo capability.

Another example of the wireless headsets is stereo headsets that are built to deliver good listening experience, such as music playback. One stereo headset for this type of applications consists of two speakers that are held in position over the left and right ears of a user by a flexible headband or hooks on the individual earpiece. Some of the available stereo headsets are equipped with microphones and thus can also be used for communications. However, current stereo headsets are usually large in size and hard-wired between the two speakers, resulting in a lack of mobility and flexibility as compared to mono headsets.

Speaker phones are complex communication devices designed to effectively function in environments where loud echoes are received by the microphones from a broadcasting speaker. The device is not required to be physically worn by a user for communication and its effective pickup range is not limited to only the primary user. The communication quality of such a system is usually gauged by the acoustic echo cancellation capabilities of such a device. Speaker phones have limited mobility after installation and are typically not suitable for stereo audio streaming due to the nature of the application.

It is apparent that current headsets are designed for one or two applications, thus a user has to carry multiple devices for various applications under different circumstances.

Therefore, the present invention provides a wireless hybrid headset that can be used as a mono headset for hands-free communications, a stereo headset for music listening, and a speaker phone for teleconferencing.

### SUMMARY OF THE INVENTION

One embodiment of the present invention provides a wireless electronic device for audio signal procession and transmission. The wireless electronic device comprises a primary unit being worn on one ear of a user, wherein the primary unit comprises a main electrical circuitry for receiving, processing, and transmitting audio signals, wherein the audio signals may be received from different sources; a speaker being electronically coupled to the main electrical circuitry for outputting the processed audio signals to a user; a microphone being electronically coupled to the main electrical circuitry for audio signal inputting to the main electrical circuitry; an interface being electronically coupled to the main electrical circuitry for allowing connection with a secondary attachment; and a power source for powering the wireless electronic device; whereby when the interface is not connected with the secondary attachment, the wireless electronic device functions as a mono headset.

In another embodiment of the wireless electronic device, the primary unit further comprises a catching mechanism for holding the primary unit in position with respect to the ear.

In another embodiment of the wireless electronic device, the main electrical circuitry comprises four major functional blocks: an audio processing unit for the input/output audio processing, a radio unit providing wireless capability for data exchange with a base station, a logic control unit for managing the flow control and interaction between different functional units, and a power control unit for managing the power source. In a further embodiment of the wireless electronic device, the audio processing unit comprises an analog to digital converter for converting input signals to digital form, a digital signal processor for processing the digital signals before it is sent to the radio unit for transmission, a decoder for reconstruction of received audio data from a base station, and a digital to analog converter for producing analog audio signals so that audible sound can be reproduced through the speaker. In yet another further embodiment of the wireless electronic device, the digital signal processor further comprises noise suppression algorithms to reduce environment and background noise.

In another embodiment of the wireless electronic device, the power source is a battery.

In another embodiment of the wireless electronic device, it further comprises a secondary unit as the secondary attachment, and a connector means being electronically coupled with the primary and secondary units so that the audio signals can be transmitted from the primary unit to the secondary unit; wherein the secondary unit comprises a speaker for outputting the audio signals processed by the primary unit to another ear of the user; whereby when the secondary unit is electronically coupled to the primary unit, the wireless electronic device can function as a stereo headset.

In another embodiment of the wireless electronic device, the secondary unit further comprises a second power source; wherein the second power source can function as a backup power source for the primary unit. In a further embodiment of the wireless electronic device, the second power source is a battery.

In another embodiment of the wireless electronic device, the secondary unit further comprises a catching mechanism for holding the secondary unit in position with respect to the ear.

In another embodiment of the wireless electronic device, the secondary unit further comprises a microphone for inputting audio signals.

In another embodiment of the wireless electronic device, the interface is an I/O socket, and the connector means is a connector cable that has one end being electrically coupled to the secondary unit and another end having a mating port fitting into the I/O socket; thereby the primary unit and secondary unit are electronically coupled.

In another embodiment of the wireless electronic device, it further comprises a loudspeaker system as the secondary attachment and a connecting mechanism for electronically coupling the primary unit and the loudspeaker system; thereby the wireless electronic device can function as a speaker phone system.

In another embodiment of the wireless electronic device, the interface of the primary unit is a plug port, and the connecting mechanism is a connecting cable with a mating port; whereby the mating port is plugged into the plug port, so that the audio signal from the primary unit can be amplified and converted to audible sound by the loudspeaker system.

In another embodiment of the wireless electronic device, the connecting mechanism contains a special adaptor cable having a general purpose connector socket that can be attached and interfaced to many speaker systems commonly available in market.

In another embodiment of the wireless electronic device, the primary unit further comprises an antenna for receiving audio signals from an external station. In a further embodiment of the wireless electronic device, the external station is selected from the group consisting of Bluetooth enabled mobile phone, PDA, desktop, laptop or any compatible device that acts as a gateway to external telephone network or as a source of stereo audio.

The objectives and advantages of the invention will become apparent from the following detailed description of preferred embodiments thereof in connection with the accompanying drawings.

### BRIEF DESCRIPTION OF THE DRAWINGS

Preferred embodiments according to the present invention will now be described with reference to the Figures, in which like reference numerals denote like elements.

FIG. 1 shows a plan view of a wireless hybrid headset in accordance with one embodiment of the present invention.

FIG. 2 is an electrically functional block diagram of the wireless hybrid headset in accordance with one embodiment of the present invention.

FIG. 3 is an electrically functional block diagram of the wireless hybrid headset in accordance with another embodiment of the present invention.

FIG. 4 shows a plan view of the speaker phone system using the hybrid headset in accordance with one embodiment of the present invention.

FIG. 5 shows a plan view of the speaker phone system using the hybrid headset in accordance with another embodiment of the present invention.

FIG. 6 is an electrically functional block diagram of the speaker phone system in accordance with one embodiment of the present invention.

FIG. 7 is a functional block diagram of the main electric circuitry in accordance with one embodiment of the present invention.

FIG. 8 shows how the master device can be setup as a mono headset for communication.

### DETAILED DESCRIPTION OF THE INVENTION

The present invention may be understood more readily by reference to the following detailed description of certain embodiments of the invention.

Throughout this application, where publications are referenced, the disclosures of these publications are hereby incorporated by reference, in their entireties, into this application in order to more fully describe the state of art to which this invention pertains.

It is to be noted that the description herein below will employ certain specific figures and configurations to illustrate the principles of the present invention, but the invention can be practiced without the specifics. On the other hand, many details are not provided herein for the sake of not obscuring the invention.

The present invention provides a wireless hybrid headset that is versatile in adopting in multiple applications including mono headset, stereo headset, and speaker phone.

Now referring to FIG. 1, there is provided a plan view of a wireless hybrid headset in accordance with one embodiment of the present invention. As shown in FIG. 1, the wireless hybrid headset 1 comprises a primary unit 1a being worn on one ear of a user, and a secondary unit 1b being worn on the other ear of the user, where the primary unit 1a and secondary unit 1b are connected by an interconnecting means 8 such as a connector cable. As discussed hereinafter in detail, the primary unit 1a is a fully functional unit so that it can function as a mono headset for hands-free communications when it is alone, a stereo headset in combination with the secondary unit 1b, and a speaker phone in combination with an external speaker; and the secondary unit 1b is a partially functional unit so that it has to be used with the primary unit 1a to function as a stereo headset.

The primary unit 1a comprises a speaker 2a for outputting audio signals to a user; a main electrical circuitry 3a for processing audio signals; a power source (e.g., a battery pack) 4a for powering the headset; a microphone 5a for inputting audio signals to the main electrical circuitry; an ear-hook 6a for providing supporting means allowing the headset to be worn by one ear of the user; and an interface (e.g., an I/O socket) 7a for allowing connection with a secondary attachment such as the secondary unit 1b and an external speaker. The speaker 2a, power source 4a, microphone 5a, and ear-hook 6a may be any suitable means known to those skilled in the art; thus there is no more detailed description of these items in order not to obscure the principles of the present invention.

Still referring to FIG. 1, the secondary unit 1b comprises a speaker 2b for outputting audio signals to a user, and an ear-hook 6b for providing supporting means allowing the headset to be worn by one ear of the user. The secondary unit 1b may optionally further comprise a power source (e.g., a battery pack) 4b, and a microphone 5b. The connector cable 8 has two ends, one being attached to the secondary unit 1b and the other end having a mating connector 7b for docking the connector cable to the primary unit 1a.

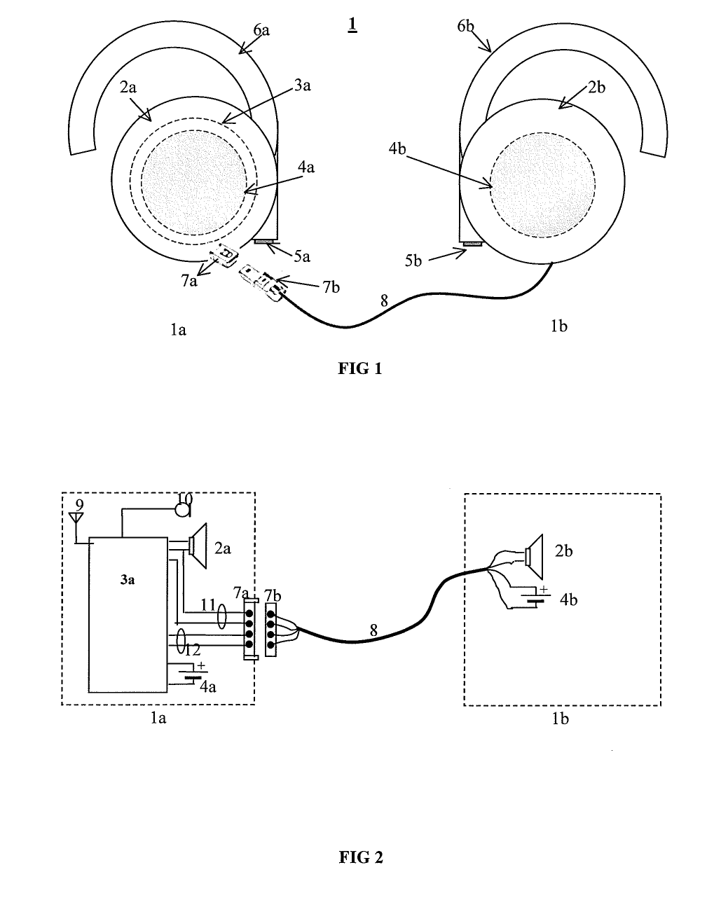

Now referring to FIG. 2, there is provided an electrically functional block diagram of the wireless hybrid headset in accordance with one embodiment of the present invention. The main electrical circuitry 3a is powered by the battery pack 4a and controls all other components. As shown in FIG. 2, the primary unit 1a further comprises an antenna 9 and an acoustic sensor 10 that are connected directly to the main electrical circuitry board 3a. The connector 7a, 7b can be interchanged for few different types of configurations but must have a minimum of 2 pins for connection of a speaker pair. One pin group 11 consists of 2 pins that are routed on to the connector socket for connection to the secondary unit. Another pin group 12 consists of 2 optional pins which accept additional power connections from the battery pack from the secondary unit as a backup power source. The electrical connection between the 4-pin connector 7a from the primary unit 1a and secondary unit 1b is achieved through the mating connector 7b and cable assembly 8.

The docking mechanism between the connector socket 7a, 7b and connector cable 8 allows the device to function as a mono headset or as a stereo headset at user's discretion. The transformation between the mono headset and stereo headset and vice versa is technically seamless.

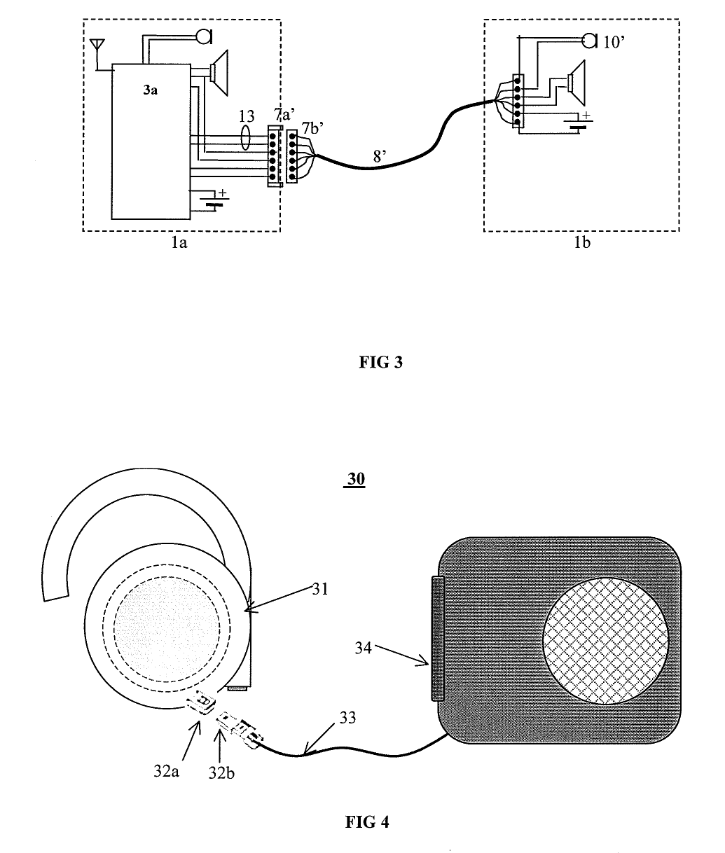

Now referring to FIG. 3, there is provided an electrically functional block diagram of the wireless hybrid headset in accordance with another embodiment of the present invention. The diagram shown in FIG. 3 is identical to the one shown in FIG. 2 except that the secondary unit 1b has an acoustic sensor 10′, resulting an extra pin group 13 in the primary unit 1a, and the modifications in the connectors 7a′, 7b′ and connector cable 8′.

Now there is provided a brief description of the operation of the wireless hybrid headset discussed above.

When the wireless hybrid headset is used as a mono headset for hands-free communications, only the primary unit 1a is needed because the primary unit 1a contains the main electric circuitry 3a for operation in standalone mode. Under this configuration, it functions as mono headset. When attached on the ear, it functions as a full featured conventional hands-free kit.

For stereo music, the secondary unit 1b can be plugged to the primary unit 1a through a connector cable 8 to form a stereo headset. In this setup, the headset can also function as a hands free kit for communication. During communication, both primary unit 1a and secondary unit 1b may playback the same speech signal.

The mechanism of using cable 8, mating connectors 7a, 7b to link up the primary unit and secondary unit allows the use of an optional battery pack 4b to be implemented in the secondary unit 1b, thus providing additional power supply to the primary unit 1a. The optional battery supply offers at least two advantages: extension of the battery operation time; and Minimization/equalization of the weight difference between the primary unit and secondary unit to ensure comfort of wearing the headsets.

Now referring to FIG. 4, there is provided a plan view of the speaker phone system using the hybrid headset in accordance with one embodiment of the present invention. As shown in FIG. 4, the speaker phone system 30 comprises a primary unit 31 with a plug port 32a, an external loudspeaker system 34, and a connecting cable 33 with a mating port 32b, where the connecting cable 33 connects the primary unit 31 and the speaker phone 34 to form the speaker phone system. The audio signal from the primary unit 31 will be amplified and converted to audible sound by the loudspeaker system 34.

Now referring to FIG. 5, there is provided a plan view of the speaker phone system using the hybrid headset in accordance with another embodiment of the present invention. As shown in FIG. 5, the speaker phone system 30′ is identical to the one shown in FIG. 4 except for the connecting mechanism. The connecting mechanism contains a special adaptor cable having a general purpose connector socket 35a that can be attached and interfaced to many speaker systems commonly available in market. For example, 3.5 mm socket 35b can be used; in this case, most PC compatible speaker systems can be utilized as the external speaker to the master device.

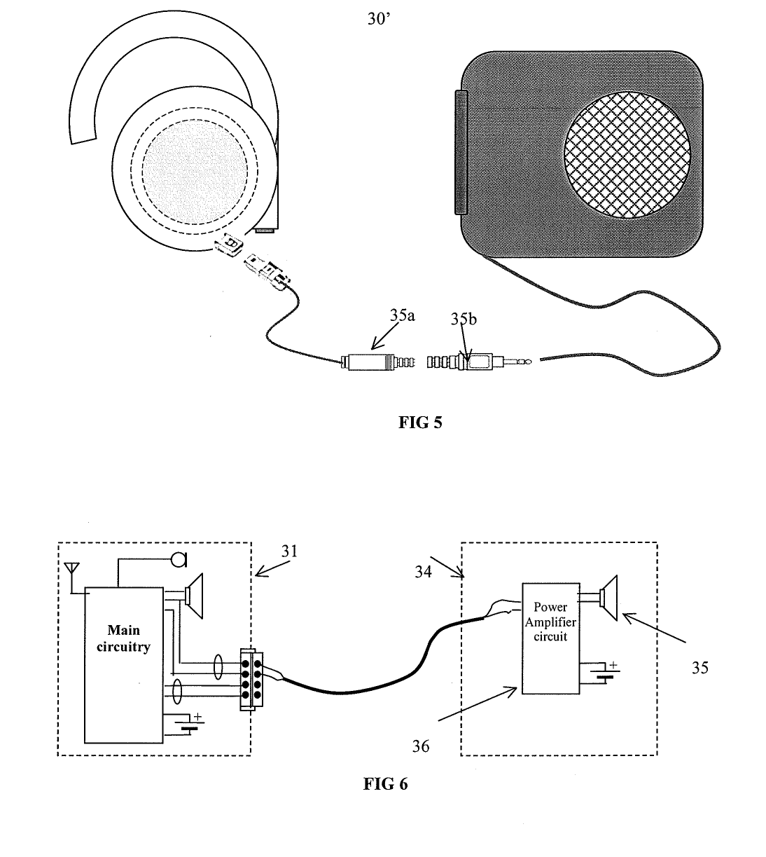

Now referring to FIG. 6, there is provided an electrically functional block diagram of the speaker phone system in accordance with one embodiment of the present invention. The diagram shown in FIG. 6 is identical to the one shown in FIG. 2 except that the secondary unit is replaced by a loudspeaker system 34. The loudspeaker system 34 comprises a speaker 35 and a power amplifier circuit 36 which amplifies the audio signal from the primary unit to drive the loudspeakers.

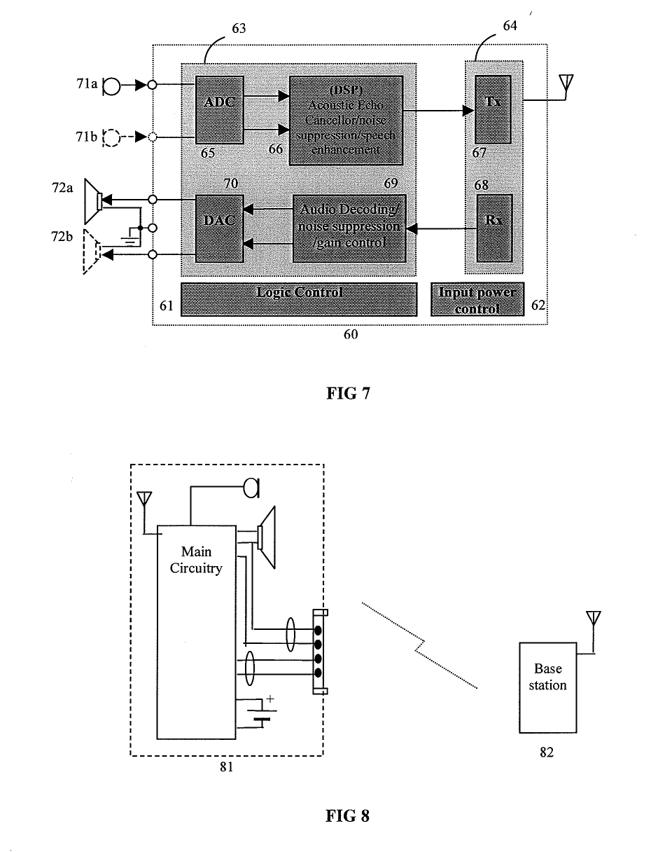

Now referring to FIG. 7, there is provided a functional block diagram of the main electric circuitry in accordance with one embodiment of the present invention. The main electrical circuitry 60 comprises four major functional blocks: an audio processing unit 63, a radio unit 64, a logic control unit 61, and a power control unit 62. The audio processing unit 63 is responsible for the input/output audio processing whereas the radio unit 64 (e.g., Bluetooth) provides the wireless capability for data exchange with a base station. The logic control unit 61 manages the flow control and interaction between different functional units whereas the input power control unit 62 manages the primary power and backup power source from the secondary unit.

For audio input, signals from acoustic sensors 71a/71b are converted to digital form through an ADC (analog to digital converter) 65. The signal can then be processed by a digital signal processor 66 before it is sent to the transmitting end 67 of the radio unit 64 for transmission. In this embodiment, due to the close proximity between the microphone 71a/71b and the headset speaker 72a/72b, echoes will be picked by the microphone due to acoustic coupling. Under these circumstances, an acoustic echo canceller (AEC) is included to handle the echo effect. Noise suppression algorithms can also be added to reduce environment and background noise. Microphone array processing can be deployed to reduce interference signals and to further enhance speech quality with the addition of microphone array modules. Automatic Gain Control (AGC) can be included to ensure speech input is maintained at consistent and comfortable levels.

At the receiving end 68 of the radio unit 64, audio data received from a base station may have been pre-processed in a pre-defined format, compression or encryption techniques may have been applied to the audio data. This audio data is then passed to the decoder 69 for reconstruction of the raw audio data. The audio waveform data is then streamed to a DAC (digital to analog converter) 70 to produce an analog audio signal so that audible sound can be reproduced through the speaker 72a/72b. To improve the communication quality while in hands-free mode, noise suppression algorithms can also be applied to the received signal to reduce environment and background noise. Automatic gain adjustment of the speaker volume can also be implemented when operating in noisy environments.

FIG. 8 shows how the master device can be setup as a mono headset for communication. In standalone mode, the master device is simply a mono headset. In a typical setup, RF link is setup between the master device 81 and a base station 82 which can be a wireless eg Bluetooth enabled mobile phone, PDA, desktop, laptop, another headset system or any compatible device that acts as a gateway to external telephone network.

While the present invention has been described with reference to particular embodiments, it will be understood that the embodiments are illustrative and that the invention scope is not so limited. Alternative embodiments of the present invention will become apparent to those having ordinary skill in the art to which the present invention pertains. Such alternate embodiments are considered to be encompassed within the spirit and scope of the present invention. Accordingly, the scope of the present invention is described by the appended claims and is supported by the foregoing description.

What is claimed is:

1. A wireless electronic device for audio signal procession and transmission, comprising:
a primary unit being worn on one ear of a user, wherein the primary unit comprises:
a main electrical circuitry for receiving, processing, and transmitting audio signals, wherein the audio signals may be received from different sources;
a speaker being electronically coupled to the main electrical circuitry for outputting the processed audio signals to a user;
a microphone being electronically coupled to the main electrical circuitry for audio signal inputting to the main electrical circuitry;
an interface being electronically coupled to the main electrical circuitry for allowing connection with a secondary attachment; and
a power source for powering the wireless electronic device;
whereby when the interface is not connected with the secondary attachment, the wireless electronic device functions as a mono headset.

2. The wireless electronic device of claim 1, wherein the primary unit further comprises a catching mechanism for holding the primary unit in position with respect to the ear.

3. The wireless electronic device of claim 1, wherein the main electrical circuitry comprises four major functional blocks: an audio processing unit for the input/output audio processing, a radio unit providing wireless capability for data exchange with a base station, a logic control unit for managing the flow control and interaction between different functional units, and a power control unit for managing the power source.

4. The wireless electronic device of claim 3, wherein the audio processing unit comprises an analog to digital converter for converting input signals to digital form, a digital signal processor for processing the digital signals before it is sent to the radio unit for transmission, a decoder for reconstruction of received audio data from a base station, and a digital to analog converter for producing analog audio signals so that audible sound can be reproduced through the speaker.

5. The wireless electronic device of claim 4, wherein the main electrical circuitry further comprises echo-cancellation algorithms for full duplex communication.

6. The wireless electronic device of claim 4, wherein in the main electrical circuitry further comprises noise suppression algorithms to reduce environment and background noise.

7. The wireless electronic device of claim 4, wherein in the main electrical circuitry further comprises microphone array processing algorithms for speech enhancement and directional interference noise cancellation.

8. The wireless electronic device of claim 1, wherein the power source is a battery.

9. The wireless electronic device of claim 1, further comprises a secondary unit as the secondary attachment, and a connector means being electronically coupled with the primary and secondary units so that the audio signals can be transmitted from the primary unit to the secondary unit;
wherein the secondary unit comprises:
a speaker for outputting the audio signals processed by the primary unit to another ear of the user;
whereby when the secondary unit is electronically coupled to the primary unit, the wireless electronic device can function as a stereo headset.

10. The wireless electronic device of claim 7, wherein the secondary unit further comprises a second power source; wherein the second power source can function as a backup power source for the primary unit.

11. The wireless electronic device of claim 8, wherein the second power source is a battery.

12. The wireless electronic device of claim 7, wherein the secondary unit further comprises a catching mechanism for holding the secondary unit in position with respect to the ear.

13. The wireless electronic device of claim 7, wherein the secondary unit further comprises a microphone for inputting audio signals.

14. The wireless electronic device of claim 7, wherein the interface is an I/O socket, and the connector means is a connector cable that has one end being electrically coupled to the secondary unit and another end having a mating port fitting into the I/O socket; thereby the primary unit and secondary unit are electronically coupled.

15. The wireless electronic device of claim 1, further comprises a loudspeaker system as the secondary attachment and a connecting mechanism for electronically coupling the primary unit and the loudspeaker system; thereby the wireless electronic device can function as a speaker phone system.

16. The wireless electronic device of claim 13, wherein the interface of the primary unit is a plug port, and the connecting mechanism is a connecting cable with a mating port; whereby the mating port is plugged into the plug port, so that the audio signal from the primary unit can be amplified and converted to audible sound by the loudspeaker system.

17. The wireless electronic device of claim 13, wherein the connecting mechanism contains a special adaptor cable having a general purpose connector socket that can be attached and interfaced to many speaker systems commonly available in market.

18. The wireless electronic device of claim 1, wherein the primary unit further comprises an antenna for receiving audio signals from an external station.

19. The wireless electronic device of claim 16, wherein the external station is selected from the group consisting of Bluetooth enabled mobile phone, PDA, desktop, laptop, another headset system or any compatible device that acts as a gateway to external telephone network or as a source of stereo audio.
